(19) United States
(12) Patent Application Publication
(10) Pub. No.: US 2020/0196152 A1
(43) Pub. Date: Jun. 18, 2020

(54) Method and Apparatus for Restoring Internet Access by Local Area Network Device

(71) Applicant: Huawei Technologies Co., Ltd., Shenzhen (CN)

(72) Inventors: Ji Ding, Shanghai (CN); Junxin Lu, Shanghai (CN)

(21) Appl. No.: 16/629,244

(22) PCT Filed: Jul. 7, 2017
(86) PCT No.: PCT/CN2017/092277

§ 371 Date: Jan. 7, 2020

(51) Int. Cl. H04W 12/08; H04L 29/12; H04W 48/16; H04W 12/00; H04L 29/06

(52) U.S. Cl. CPC H04W 12/0806; H04L 61/2514; H04L 61/2015; H04L 63/0272; H04W 12/0051; H04W 12/0808; H04L 63/0236; H04W 48/16

(57) ABSTRACT

A method for restoring internet access by a local area network device includes obtaining, by a local area network device, a whitelist stored in the local area network device, and accessing, by the local area network device based on offer information that includes a private network address provided by a router and that is in the whitelist, the internet by using the private network address provided by the router.

### TECHNICAL HELD

The present invention relates to the field of communications, and in particular, to a method and an apparatus for restoring internet access by a local area network device.

### BACKGROUND

In the prior art, there are two WiFi (Wireless Fidelity) routers A and B, and corresponding gateway devices are G1 and G2, respectively. If LAN (Local Area Network, local area network) interfaces of the router A and the router B are connected together in a wired manner, to form a local area network with a plurality of DHCP (Dynamic Host Configuration Protocol, dynamic host configuration protocol) servers (server).

When accessing the router A or the router B, a terminal receives a DHCP OFFER1 that is delivered by the router A serving as the gateway device G1 to the terminal and a DHCP OFFER2 that is delivered by the router B serving as the gateway device G2 to the terminal, respectively. The terminal uses a DHCP OFFER that is first received, and discards a DHCP OFFER that is later received.

When a gateway device corresponding to the DHCP OFFER that is first received by the terminal is the router A, because an uplink network interface of the router A is not connected to the Internet, the router A cannot access the interact. Consequently, the terminal cannot access the internet.

Settings UI (user interface settings) is expressed as follows: If the terminal first receives and uses the DHCP OFFER1 provided by the router A, an IP address of a network segment corresponding to the gateway device G1 is seen in the Settings UI; or if the terminal first receives and uses the DHCP OFFER2 provided by the router B, an IP address of a network segment corresponding to the gateway device G2 is seen in the Settings UI.

A gateway device address of the router B is 192.168.1.1. When an IP address of the terminal is assigned by the router B, an IP address seen in the Settings UI of the terminal is 192.168.1.137 (137 is a variable IP value).

Currently, the industry does not have a solution for this scenario, and a software self-restoring method is lacked.

### SUMMARY

Embodiments of the present invention provide a method for restoring internet access by a local area network device and a local area network device. Compared with the prior art, when a local area network device cannot be connected to the internet, a whitelist stored on the local area network device is obtained. The internet is accessed by using a private network address provided by a router based on offer information that includes the private network address provided by the router and that is in the whitelist.

According to a first aspect, an embodiment of the present invention provides a method for accessing the internet by a local area network device, and the method includes: obtaining, by a local area network device, a whitelist stored on the local area network device, where the whitelist includes offer information of a private network address provided by a router; and obtaining, by the local area network device based on the offer information, the private network address corresponding to the router, and accessing the internet by using the private network address.

According to this aspect, a local area network device obtains a whitelist stored on the local area network device; and the local area network device accesses, based on offer information that includes a private network address provided by a router and that is in the whitelist, the internet by using the private network address provided by the router. In this way, it is implemented that the local area network device selects the offer information in the whitelist to access the internet,

With reference to a first possible implementation of the first aspect, before the obtaining, by a local area network device, a whitelist stored on the local area network device, the method further includes: sending, by the local area network device, a DHCP discover packet; receiving, by the local area network device, a DHCP offer packet sent by at least one router in a local area network in which the local area network device is located; storing, by the local area network device, the DHCP offer packet; determining, by the local area network device based on information in the stored DHCP offer packet, whether a private network address that is provided by a router and that is included in the DHCP offer can be used to access the internet, where the DHCP offer packet includes the private network address provided by the router; and if the local area network device can access the internet by using the private network address provided by the router, storing the corresponding private network address and an SSID of the connected router device in the whitelist.

In this possible implementation, clarifying how to form a whitelist provides a use basis for use of the whitelist in other implementations of the present invention.

According to a second aspect, an embodiment of the present invention provides a local area network device, and the device includes at least one memory that stores an instruction and at least one wireless fidelity WiFi chip, where the memory is configured to store the instruction and a whitelist, the whitelist includes a private network address provided by a router; and when the instruction is executed by the at least one WiFi chip, the local area network device is enabled to perform the following steps: obtaining the stored whitelist; and accessing, based on offer information that includes the private network address provided by the router and that is in the whitelist, the internet by using the private network address provided by the router.

According to this aspect, a local area network device obtains a whitelist stored on the local area network device; and the local area network device accesses, based on offer information that includes a private network address provided by a router and that is in the whitelist, the internet by using the private network address provided by the router. In this way, it is implemented that the local area network device selects the offer information in the whitelist to access the internet.

With reference to a first possible implementation of the second aspect, the WiFi chip is further configured to perform the following steps: sending, by the local area network device, a DHCP discover packet; receiving, by the local area network device, DHCP offer packets sent by all routers in a local area network in which the local area network device is located; storing, by the local area network device, the DHCP offer packets; determining, by the local area network device based on information in the stored DHCP offer packets, whether a private network address that is provided by a router and that is included in the DHCP offer can be used to access the internet; and if the local area network device can access the internet by using the private network address provided by the router, storing the corresponding DHCP offer packet and an SSID of the connected router device in the whitelist.

In this possible implementation, clarifying how to form a whitelist provides a use basis for use of the whitelist in other implementations of the present invention.

According to the foregoing embodiment, a local area network device obtains a whitelist stored on the local area network device; and the local area network device accesses, based on offer information that includes a private network address provided by a router and that is in the whitelist, the internet by using the private network address provided by the router. In this way, it is implemented that the local area network device selects the offer information in the whitelist to access the internet.

### BRIEF DESCRIPTION OF DRAWINGS

To describe the technical solutions in the embodiments of the present invention or in the prior art more clearly, the following briefly introduces the accompanying drawings required for describing the embodiments or the prior art.

FIG. 1 is a local area network system according to a first embodiment of the present invention;

FIG. 2 is a corresponding table of a gateway device and a DHCP Offer packet of the gateway device according to a first embodiment of the present invention;

FIG. 3 is a flowchart of a method for diagnosing internet restoring by a local area network device according to a second embodiment of the present invention;

FIG. 4 is DHCP configuration information before a local area network device restores internet access according to a third embodiment of the present invention;

FIG. 5 is DHCP configuration information after a local area network device restores Internet access according to a third embodiment of the present invention; and

FIG. 6 is a schematic structural diagram of a local area network device according to a fourth embodiment of the present invention.

### DESCRIPTION OF EMBODIMENTS

To make the objectives, technical solutions, and advantages of the embodiments of the present invention clearer, the following further describes the embodiments of the present invention in detail with reference to the accompanying drawings.

The technical means used in the embodiments of the present invention may be as follows: A local area network device obtains a whitelist stored on the local area network device, and the local area network device accesses, based on offer information that includes a private network address provided by a router and that is in the whitelist, the internet by using the private network address provided by the router.

### Embodiment 1 of the Present Invention

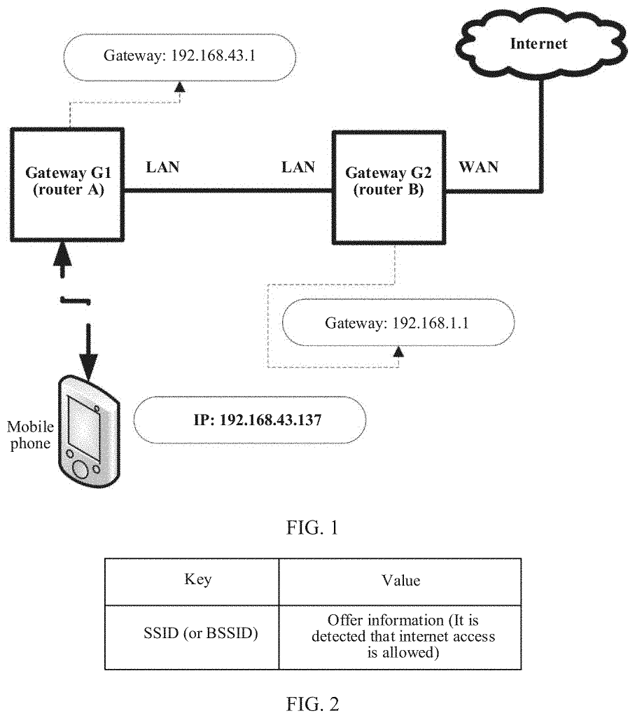

In a local area network system shown in FIG. 1, a gateway device G1 (constituted by a router A) and a gateway device G2 (constituted by a router B) are connected through a local area network (LAN) interface, and a wide area network WAN interface of the gateway device G2 is connected to the internet (Internet)). A local area network device (a mobile phone is used as an example below) is connected to the gateway device G1 or G2 in a wired or wireless manner. In this example, a mobile terminal is connected to the G1 in a wireless manner. A DHCP address of the G1 is, for example, 192.168,43.1, and therefore, a DHCP address of the mobile terminal connected to the G1 is, for example, 192.168.43.137. For example, a DHCP address of the gateway device G2 is 192.168.1.1. In this example, because the G1 is not directly connected to the Internet, the mobile phone cannot access the internet.

A local area network device obtains a whitelist stored on the local area network device; and the local area network device accesses, based on offer information that includes a private network address provided by a router and that is in the whitelist, the internet by using the private network address provided by the router.

For composition of the whitelist, refer to the following description. The mobile phone determines, based on a data packet type, whether a currently received data packet is a DHCP Offer packet. If the currently received data packet is a DHCP Offer packet, the mobile phone stores at least two DHCP Offer packets and at most all DHCP Offer packets. During specific storage, an SSID (service set identifier, Service Set Identifier) or a BSSID (basic service set identifier, Basic Service Set Identifier) of a gateway is used as a key to record DHCP Offer Packets content corresponding to the gateway. The BSSID is a MAC address of the gateway. For a specific storage form, refer to FIG. 2. As shown in FIG. 2, the left column is a gateway device name (Key), and the right column is a DHCP Offer packet. For example, a gateway device 1 (a gateway1) corresponds to DHCP INFO 1, and a gateway device 2 (a gateway2) corresponds to DHCP INFO 2. The DHCP INFO 1 and the DHCP INFO 2 include IP addresses corresponding to the gateway devices. For example, an IP address corresponding to the gateway device 1 is 192.168.43.1, and an IP address corresponding to the gateway device 2 is 192.168.1.1.

According to the embodiment 1 of the present invention, a local area network device obtains a whitelist stored on the local area network device; and the local area network device accesses, based on offer information that includes a private network address provided by a router and that is in the whitelist, the internet by using the private network address provided by the router. In this way, it is implemented that the local area network device selects the offer information in the whitelist to access the internee.

### Embodiment 2 of the Present Invention

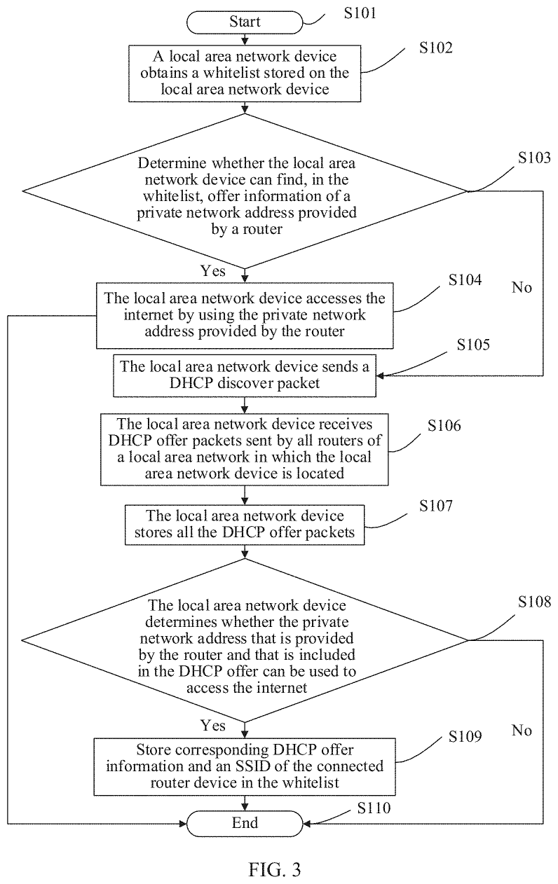

As shown in FIG. 3, this embodiment describes a forming process and a using process of the whitelist.

Step S101: Start.

Step S102: A local area network device obtains a whitelist stored on the local area network device.

Step S103: Determine whether the local area network device can find, in the whitelist, offer information of a private network address provided by a router. When a determining result is yes, go to step S104. If a determining result is no, go to step S105.

Step S104: The local area network device accesses the internet by using the private network address provided by the router.

Step S105: The local area network device sends a DHCP discover packet.

Step S106: The local area network device receives DHCP offer packets sent by all routers of a local area network in which the local area network device is located.

Step S107: The local area network device stores all the DHCP offer packets.

Step S108: The local area network device determines whether to access the internet by using the private network address that is provided by the router and that is included in the DHCP offer. If a determining result is yes, perform step S109. If a determining result is no, perform step S110.

Step S109: Store all corresponding DHCP offer information and an SSID of the connected router device in the whitelist.

Step S110: End.

According to this embodiment of the present invention, a local area network device (for example, a mobile phone' determines whether offer information exists in a whitelist of the local area network device. If the offer information exists in the whitelist, the local area network device accesses the internet by using the offer information in the whitelist. If the offer information does not exist in the whitelist, the mobile phone sends a DHCP discover packet in a local area network, receives, based on the DHCP discover packet, DHCP offer packets sent by all routers in a local area network in which the local area network device is located, and stores the DHCP offer packets. The local area network device determines whether private network addresses provided by the stored DHCP offer packets enable the local area network device to access the internet. If the private network addresses provided by the stored DHCP offer packets enable the local area network device to access the internet, the corresponding DHCP offer information and an SSID of the connected router device are stored in the whitelist. In this way, the local area network device may obtain, by using the whitelist, the private network address for the local area network device to access the internet, to implement internet access of the local area network device.

### Embodiment 3 of the Present Invention

In this embodiment of the present invention, with reference to the embodiment 1 and the embodiment 2, a change of a UI setting interface of a mobile phone is as follows:

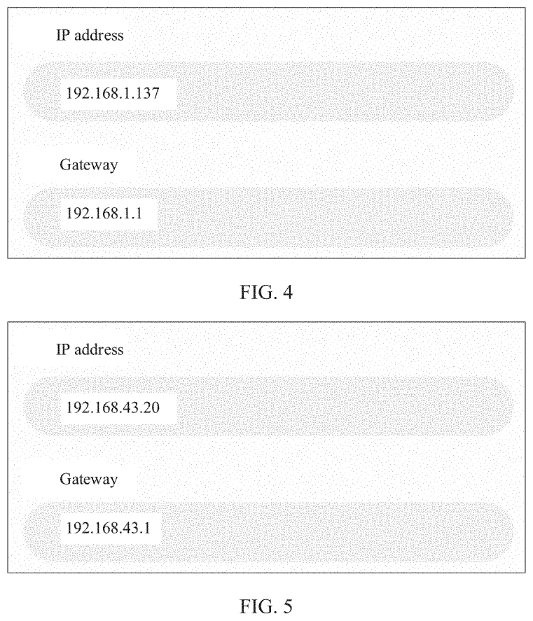

When the mobile phone is directly connected to a G2, the UI setting interface is shown in FIG. 4. In FIG. 4, a gateway device address of the G2 is 192.168.1.1. A corresponding IP address of the mobile phone is 192.168.1,137.

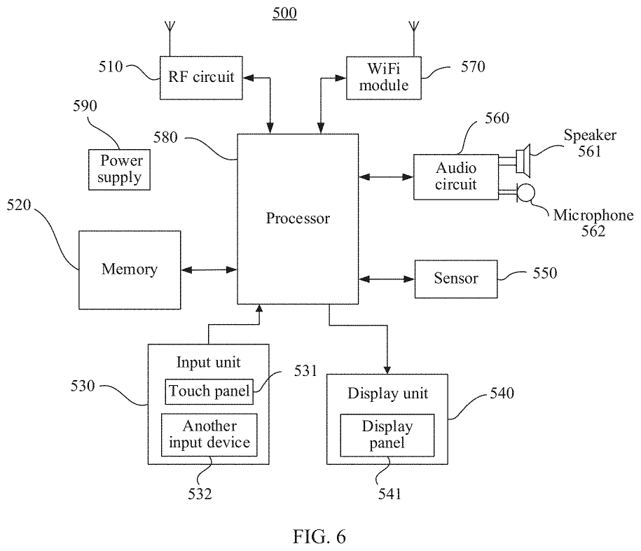

Even if the mobile phone does not change a connection relationship and is still directly connected to the C12, a change of the UI setting interface is shown in FIG. 5. In FIG. 6, a gateway device address of the G1 is 192.168.43.1. A corresponding IP address of the mobile phone is 192.168.43.20.

According to this embodiment of the present invention, even if the mobile phone does not change a connection relationship and is still directly connected to a gateway device (for example, the G2) that cannot access the internet in the prior art, internet access of the mobile phone can be implemented.

### Embodiment 4 of the Present Invention

As shown in FIG. 6, in this embodiment, a mobile phone, a specific form of a local area network device, is used as an example to describe the present invention in detail.

It should be understood that a mobile phone 500 shown in FIG. 6 is merely an example of the local area network device, and the mobile phone 500 may have more or fewer components than those shown in FIG. 6, and combine two or more components, or may have a different component arrangement. Various components shown in FIG. 6 may be implemented in hardware that includes one or more signal processing and/or application-specific integrated circuits, in software, or in a combination of hardware and software.

Now, a mobile phone is used as an example for specific description. FIG. 6 is a schematic structural diagram of a mobile phone according to an embodiment 1 of the present invention. As shown in FIG. 6, the mobile phone includes a memory 501, a central processing unit (Central Processing Unit, CPU for short below) 503, a peripheral interface 504, an RF circuit 505, an audio circuit 506, a speaker 507, a power management chip 508, an input/output (I/O) subsystem 509, another input/control device 510, and an external port 504. These components communicate with each other by using one or more communication buses or signal wires 512.

It should be noted that the mobile phone provided in this embodiment is merely an example of a mobile terminal, and the mobile terminal involved in this embodiment of the present invention may have more or fewer components than those shown in FIG. 6, and combine two or more components, or may have a different component arrangement or configuration. Various components may be implemented in hardware that includes one or more signal processing and/or application-specific integrated circuits, in software, or in a combination of hardware and software.

The following describes the mobile phone used for processing a message and provided in this embodiment in detail.

The local area network device involved in this embodiment of the present invention may include a mobile terminal. The mobile terminal may include a mobile phone, a tablet computer, a PDA (Personal Digital Assistant, personal digital assistant), a POS (Point of Sales, point of sales), an in-vehicle computer, or the like.

An example in which the mobile terminal is a mobile phone is used. FIG. 6 is a block diagram of a partial structure of a mobile phone 500 related to this embodiment of the present invention. Referring to FIG. 6, the mobile phone 100 includes components such as an RF (Radio Frequency, radio frequency) circuit 510, a memory 520, an input unit 530, a display unit 540, a sensor 550, an audio circuit 560, a WiFi (wireless fidelity, wireless fidelity) module 570, a processor 580, and a power supply 590. A person skilled in the art may understand that a structure of the mobile phone shown in FIG. 6 constitutes no limitation on the mobile phone. The mobile phone may include more or fewer components than those shown in FIG. 6, and combine some components, or may have a different component arrangement.

The following describes each component of the mobile phone 500 in detail with reference to FIG. 6.

The RF circuit 510 may be configured to receive/send information, or receive/send a signal during a call. Particularly, after receiving downlink information of a base station, the RF circuit 510 sends the downlink information to the processor 580 for processing. In addition, the RF circuit 510 sends data related to uplink transmission to the base station. Generally, the RF circuit includes but is not limited to an antenna, at least one amplifier, a transceiver, a coupler, an LNA (Low Noise Amplifier, low noise amplifier) and a duplexer, and the like. In addition, the RF circuit 510 may also communicate with the internet and another device through wireless communication. The wireless communication may use any communication standard or protocol, including but not limited to GSM (Global System of Mobile communication, global system for mobile communications), CPRS (General Packet Radio Service, general packet radio service), CDMA (Code Division Multiple Access, code division multiple access), WCDMA (Wideband. Code Division Multiple Access, wideband code division multiple access), LTE (Long Term Evolution, long term evolution), email, SMS (Short Messaging Service, short messaging service), and the like.

The memory 520 may be configured to store a software program and a module. The processor 580 runs the software program and the module that are stored in the memory 520 to execute functional applications and data processing of the mobile phone 500. The memory 520 may mainly include a program storage area and a data storage area. The program storage area may store an operating system, an application program required by at least one function (for example, a sound playing function or an image playing function), and the like. The data storage area may store data (for example, audio data and a phone book) created according to use of the mobile phone 500, and the like. In addition, the memory 520 may include a high-speed random access memory, and may further include a non-volatile memory, for example, at least one magnetic disk storage device, flash memory device, or another volatile solid-state storage device.

The input unit 530 may be configured to receive input digit or character information, and generate button signal input related to user setting and function control of the mobile phone 500. Specifically, the input unit 530 may include a touch control panel 531 and another input device 532. The touch control panel 531, also referred to as a touchscreen, may collect a touch operation (for example, an operation performed by a user on or near the touch control panel 531 by using any proper object or accessory such as a finger or a tablet pen) performed by the user on or near the touch control panel 531, and drive a corresponding connection apparatus according to a preset program. Optionally, the touch control panel 531 may include two components: a touch detection apparatus and a touch controller. The touch detection apparatus detects a touch position of a user, detects a signal brought by a touch operation, and transmits the signal to the ⁻touch controller. The touch controller receives touch information from the touch detection apparatus, converts the touch information into coordinates of a touch point, and then sends the coordinates to the processor 580, and can receive and execute a command sent by the processor 580. In addition, the touch control panel 531 may be implemented in a plurality of types such as a resistor type, a capacitor type, an infrared type, and a surface acoustic wave type. The input unit 530 may further include another input device 532, in addition to the touch control panel 531. Specifically, the another input device 532 may include but is not limited to one or more of a physical keyboard, a function button (for example, a volume control button or a power button), a trackball, a mouse, a joystick, and the like.

The display unit 540 may be configured to display information input by the user or information provided for the user, and menus of the mobile phone 100. The display unit 540 may include a display panel 541. Optionally, the display panel 541 may be configured in a form of an LCD (Liquid Crystal Display, liquid crystal display), an OLED (Organic Light-Emitting Diode, organic light-emitting diode), or the like. Further, the touch control panel 531 may cover the display panel 541. When detecting the touch operation on or near the touch control panel 531, the touch control panel 531 transmits the touch operation to the processor 580 to determine a touch event type, and then the processor 580 provides corresponding visual output on the display panel 541 based on the touch event type. Although the touch control panel 531 and the display panel 541 in FIG. 5 are shown as two separate components to implement input and input functions of the mobile phone 500, in some embodiments, the touch control panel 531 may be integrated with the display panel 541 to implement the input and output functions of the mobile phone 500.

The mobile phone 500 may further include at least one sensor 550, for example, an image sensor (a part of a camera), a light sensor, a motion sensor, and another sensor. Specifically, optical sensors may include an ambient optical sensor and a proximity sensor. The ambient optical sensor may adjust brightness of the display panel 541 according to brightness of an ambient light. The proximity sensor may turn off the display panel 541 and/or backlight when the mobile phone 500 approaches to an ear. As a type of the motion sensor, an accelerometer sensor may detect values of acceleration in all directions (usually, three axes), may detect a value and a direction of gravity when the accelerometer sensor is static, and may be used in an application that identifies a mobile phone posture (such as screen switching between a landscape mode and a portrait mode, a related game, or magnetometer posture calibration), a function related to vibration identification (for example, a pedometer or a strike), and the like. Other sensors such as a gyroscope, a barometer, a hygrometer, a thermometer, and an infrared sensor may be further configured in the mobile phone 500. Details are not described herein.

The audio circuit 560, a speaker 561, and a microphone 562 may provide audio interfaces between the user and the mobile phone 500. The audio circuit 560 may transmit an electrical signal converted from received audio data to the speaker 561, and the speaker 561 converts the electrical signal into a sound signal for outputting. In addition, the microphone 562 converts a collected sound signal into an electrical signal, and the audio circuit 560 converts the electrical signal into audio data after receiving the electrical signal, and then outputs the audio data to the RF circuit 508 to send the audio data to, for example, another mobile phone, or outputs the audio data to the memory 520 for further processing.

WiFi is a short-range radio transmission technology. The mobile phone 500 may help the user to, for example, receive/send an email, browse a web page, access streaming media by using the WiFi module 570, thereby providing wireless broadband internet access for the user. Although FIG. 5 shows the WiFi module 570, it may be understood that the WiFi module 570 is not a mandatory component of the mobile phone 500, and may be completely omitted based on a requirement without changing the essence of the present invention.

The processor 580 is a control center of the mobile phone 500. The processor 580 connects each part of the entire mobile phone by using interfaces and lines. The processor 580 runs or executes the software program and/or the module that are/is stored in the memory 520 and invokes data stored in the memory 520 to execute functions and data processing of the mobile phone 500, so as to perform overall monitoring on the mobile phone. Optionally, the processor 580 may include one or more processing units. Preferably, an application processor and a modern processor may be integrated into the processor 580. The application processor mainly processes an operating system, a user interface, an application program, and the like. The modem processor mainly processes wireless communication. It may be understood that the modem processor may alternatively not be integrated into the processor 580. The modem processor may be configured to execute the software program and/or the module that are/is stored in the memory 520, so as to complete the steps in any one or more of the embodiments 1 to 4. It may be understood that the memory 520 may be located in the modem processor as a part of the modern processor.

The WiFi chip in the processor 580 is configured to perform the steps in the embodiment 1 to the embodiment 3 of the present invention, and the steps include: obtaining, by a local area network device, a whitelist stored on the local area network device; and accessing, by the local area network device based on offer information that includes a private network address provided by a router and that is in the whitelist, the internet by using the private network address provided by the router.

Before the obtaining, by a local area network device, a whitelist stored on the local area network device, the method further includes: sending, by the local area network device, a DHCP discover packet; receiving, by the local area network device, DHCP offer packets sent by all routers in a local area network in which the local area network device is located; storing, by the local area network device, the DHCP offer packets; determining, by the local area network device based on information in the stored DHCP offer packets, whether a private network address that is provided by a router and that is included in the DHCP offer can be used to access the internet; and if the local area network device can access the internet by using the private network address provided by the router, storing a corresponding DHCP offer information and an SSID of the connected router device in the whitelist.

The memory 520 is further configured to store the offer information of the private network address provided by the router.

The mobile phone 500 further includes the power supply 590 (such as a battery supplying power to the components. Preferably, the power supply may be logically connected to the processor 580 by using a power management system, thereby implementing functions such as management of charging, discharging, and energy consumption by using the power management system.

Although not shown, the mobile phone 500 may further include a camera, a Bluetooth module, and the like. Details are not described herein again.

If an operation or a function of the present invention is implemented by using firmware or software, the present invention may be implemented in various formats, for example, a module, a processor, or a function. Software code may be stored in a memory unit, so that the memory unit can be driven by a processor. The memory unit is located inside or outside the processor, so that the memory unit communicates with the processor by using known components.

1. An Internet access method implemented by a local area network device, comprising:
sending a Dynamic Host Configuration Protocol (DHCP) discover packet
receiving a DHCP offer packet from a router in a local area network in which the local area network device is located, wherein the DHCP offer packet comprises a private network address provided by and corresponding to the router;
storing the DHCP offer packet
determining whether the private network address can be used to access the Internet and
storing the private network address and a service set identifier (SSID) of the router in a whitelist on the local area network device when the local area network device can access the Internet using the private network address;
obtaining the whitelist
obtaining, based on the whitelist the private network address, and
accessing the Internet using the private network address.

2. (canceled)

3. A local area network device, comprising:
a WI-FI chip; and
a memory coupled to the WI-FI chip and storing instructions that, when executed by the WI-FI chip, cause the local area network device to be configured to:
obtain a whitelist that comprises a private network address provided by a router; and
access, based on offer information that comprises the private network address, the Internet using the private network address.

4. The local area network device according to claim 3, wherein the instructions further cause the local area network device to be configured to:
send a dynamic host configuration protocol (DHCP) discover packet;
receive DHCP offer packets from routers in a local area network in which the local area network device is located, wherein the DHCP offer packets include private network addresses provided by and corresponding to the routers;
store the DHCP offer packets;
determine, based on information in the DHCP offer packets, whether each of the private network addresses can be used to access the Internet; and
store, for each of the DHCP offer packets whose corresponding private network address can be used to access the Internet, the DHCP offer packet and a service set identifier (SSID) of the router corresponding to the DHCP offer packet in the whitelist.

5. A computer program product comprising computer-executable instructions stored on a non-transitory computer-readable medium that, when executed by a processor, cause a local area network device to:
send a dynamic host configuration protocol (DHCP) discover packet
receive a DHCP offer packet from a router in a local area network in which the local area network device is located, wherein the DHCP offer packet comprises a private network address provided by and corresponding to the router;
store the DHCP offer packet
determine whether the private network address can be used to access the Internet
store the private network address and a service set identifier (SSID) of the router in a whitelist on the local area network device when the local area network device can access the Internet using the private network address;
obtain the whitelist,
obtain, based on the whitelist, the private network address; and
access the Internet using the private network address.

6. The computer program product of claim 5, wherein the instructions cause the local area network device to store DHCP offer information corresponding to the DHCP offer packet in the whitelist when the local area network device can access the Internet using the private network address.

7. The computer program product of claim 6, wherein the instructions cause the local area network device to store the DHCP offer information in the whitelist using the SSID as a key.

8. The computer program product of claim 6, wherein the instructions cause the local area network device to store the DHCP offer information in the whitelist using a basic service set identifier (B SSID) of the router as a key.

9. The computer program product of claim 5, wherein the instructions further cause the local area network device to change a user interface (UI) setting including a gateway device address.

10. The computer program product of claim 5, wherein the local area network device is a mobile phone.

11. The Internet access method of claim 1, further comprising storing DHCP offer information corresponding to the DHCP offer packet in the whitelist when the local area network device can access the Internet using the private network address.

12. The Internet access method of claim 11, wherein the DHCP offer information is stored in the whitelist using the SSID as a key.

13. The Internet access method of claim 11, wherein the DHCP offer information is stored in the whitelist using a basic service set identifier (BSSID) of the router as a key.

14. The Internet access method of claim 1, further comprising changing a user interface (UI) setting including a gateway device address.

15. The Internet access method of claim 1, wherein the local area network device is a mobile phone.

16. The local area network device of claim 4, wherein the instructions further cause the local area network device to store, for each of the DHCP offer packets whose corresponding private network address can be used to access the Internet, DHCP offer information in the whitelist.

17. The local area network device of claim 16, wherein the instructions further cause the local area network device to store the DHCP offer information in the whitelist using the SSID as a key.

18. The local area network device of claim 16, wherein the instructions further cause the local area network device to store the DHCP offer information in the whitelist using a basic service set identifier (BSSID) of the router as a key.

19. The local area network device of claim 3, wherein the instructions further cause the local area network device to change a user interface (UI) setting including a gateway device address.

20. The local area network device of claim 19, wherein the local area network device is a mobile phone.

21. The local area network device of claim 3, wherein the local area network device is a mobile phone.
